(19) United States
(12) Patent Application Publication
(10) Pub. No.: US 2010/0245705 A1
(43) Pub. Date: Sep. 30, 2010

(54) DISPLAY DEVICE

(75) Inventors: Atsuo NAKAGAWA, Mobara (JP); Eiji Oohira, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/702,813

(22) Filed: Feb. 9, 2010

(30) Foreign Application Priority Data
Mar. 31, 2009 (JP) 2009-085473

(51) Int. Cl. G02F 1/1333

(52) U.S. Cl. 349/58

(57) ABSTRACT

A display device which prevents the occurrence of flaws on a printing layer formed on a cover thereof is provided. The display device includes a display panel, a light transmitting cover which covers a display screen of the display panel, a frame-shaped printing layer which is formed on a surface of the cover which faces the display panel in a state where the printing layer surrounds a center portion of the cover by avoiding the center portion, and a coating layer which covers at least a surface of the printing layer on a side opposite to the cover and is made of a material harder than a material of the printing layer.

### CROSS-REFERENCE TO RELATED APPLICATION

The present application claims priority from Japanese application JP 2009-085473 filed on Mar. 31, 2009, the content of which is hereby incorporated by reference into this application.

### BACKGROUND OF THE INVENTION

1. Field of the Invention

The present invention relates to a display device.

2. Related Art

In a display device such as a liquid crystal display device, a display panel or a touch panel is covered with a cover (front window). As a patent document which discloses such a technique, JP-A-7-160417 (patent document 1) is named, for example. In this patent document 1, a frame-shaped printing layer is formed on a back surface of a cover (a surface of the cover which faces a display panel or a touch panel).

### SUMMARY OF THE INVENTION

There exists a possibility that flaws occur on the printing layer in assembling steps of the display device. Accordingly, it is necessary to take a countermeasure to prevent the occurrence of the flaws.

It is an object of the invention to provide a display device which can prevent the occurrence of flaws on a printing layer which is formed on a cover of the display device.

(1) According to one aspect of the invention, there is provided a display device which includes a display panel and a light transmitting cover which covers a display screen of the display panel, wherein the cover includes a frame-shaped printing layer which is formed on a surface of the cover which faces the display panel in a state where the printing layer surrounds a center portion of the cover by avoiding the center portion, and a coating layer which covers at least the printing layer and is made of a material harder than a material of the printing layer. According to the invention, the coating layer covers the printing layer and hence, it is possible to prevent the occurrence of flaws on the printing layer.

(2) In the display device having the above-mentioned constitution (1), the coating layer may also cover the center portion of the cover.

(3) In the display device having the above-mentioned constitution (1) or (2), the cover may include a base material layer and a surface layer which covers one surface of the base material layer and is made of a material harder than a material of the base material layer, and the printing layer and the coating layer may be formed on the surface layer.

### BRIEF DESCRIPTION OF THE DRAWINGS

FIG. 1 is plan view showing a display device according to an embodiment of the invention;

FIG. 2 is an exploded plan view of the display device shown in FIG. 1;

FIG. 3 is an enlarged cross-sectional view of the display device shown in FIG. 1 taken along a line III-III;

FIG. 4 is a view for explaining a modification 1 of the display device according to the embodiment of the invention;

FIG. 5 is a view for explaining a modification 2 of the display device according to the embodiment of the invention;

FIG. 6 is a view for explaining a modification 3 of the display device according to the embodiment of the invention; and

FIG. 7 is a view for explaining a modification 4 of the display device according to the embodiment of the invention.

### DESCRIPTION OF THE PREFERRED EMBODIMENT

Hereinafter, an embodiment of the invention is explained in conjunction with drawings. In this embodiment, the explanation is made by taking a liquid crystal display device as an example of a display device. However, the invention is not limited to the liquid crystal display device, and is also applicable to an organic electroluminescence display device, a plasma display device, a field emission display device or the like.

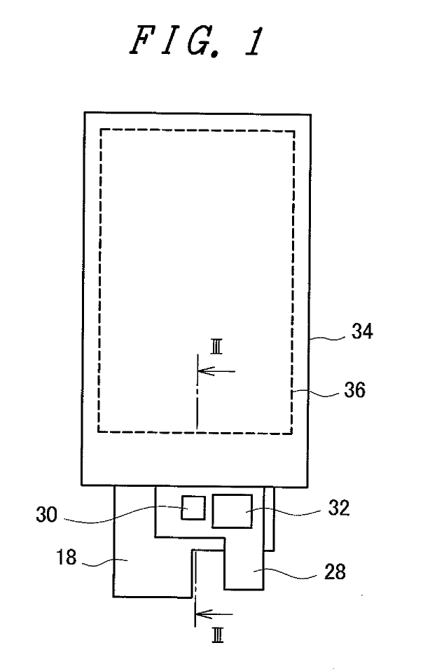

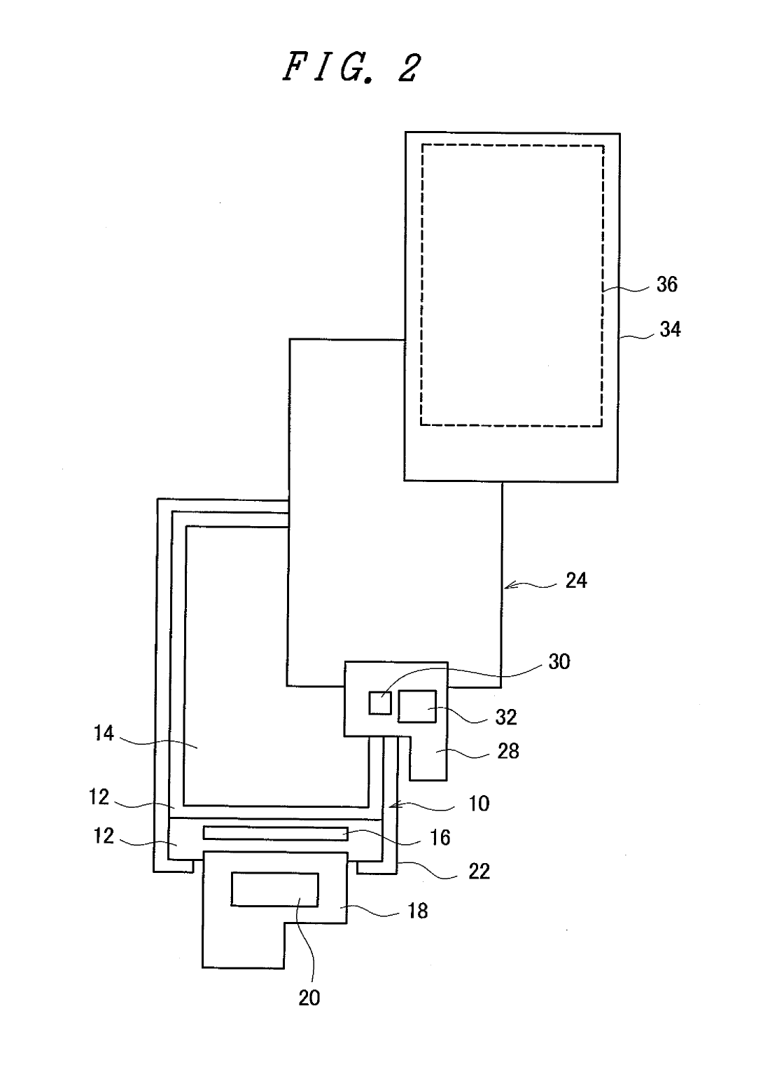

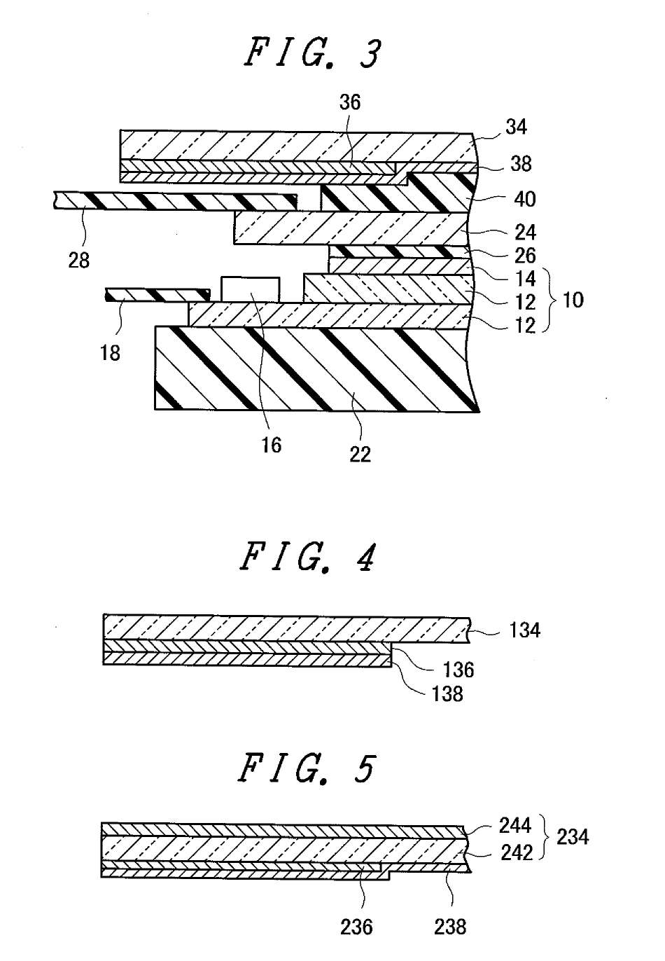

FIG. 1 is a plan view showing a display device according to the embodiment of the invention. FIG. 2 is an exploded plan view of the display device shown in FIG. 1. FIG. 3 is an enlarged cross-sectional view of the display device shown in FIG. 1 taken along a line III-III.

The display device includes a display panel 10. The display panel 10 shown in FIG. 1 and FIG. 2 is a liquid crystal display panel and includes a pair of substrates 12 (glass substrates), and liquid crystal not shown in the drawing is interposed between both substrates. One substrate 12 is a TFT (Thin Film Transistor) substrate (or an array substrate) which includes thin film transistors, pixel electrodes, lines and the like, and another substrate 12 is a color filter substrate. The display device may be driven by any driving method such as an IPS (In Plane Switching) method, a TN (Twisted Nematic) method, or a VA (Vertical Alignment) method. Electrodes and lines are formed on the substrates 12 correspondingly to a selected driving method.

A polarizer 14 is adhered to the substrate 12. On a peripheral portion of one substrate 12, an integrated circuit chip 16 which incorporates a driver circuit for driving liquid crystal therein is mounted. Further, a flexible printed circuit board 18 is mounted on an edge portion of one substrate 12. An electronic part 20 is mounted on the flexible printed circuit board 18. The display panel 10 is supported on a frame 22. The frame 22 is formed of a resin-made molded product and hence, the frame 22 is also referred to as a mold.

The display device includes a touch panel 24. As a method of operating the touch panel (or, it is said the touch screen. touch screen), an electrostatic capacitance coupling method, a resistance film method, a photo sensor method and the like are named, for example. The touch panel 24 is arranged on the display panel 10 in an overlapping manner. The touch panel 24 and the display panel 10 are adhered to each other using an adhesive layer 26. The touch panel 24 is arranged within a display region of the display panel 10 and hence, a user can perform an input operation using his finger with respect to an image displayed on the display panel 10. A flexible printed circuit board 28 is electrically connected to the touch panel 24. An integrated circuit chip 30 for controlling the touch panel 24 and an electronic part 32 are mounted on the flexible printed circuit board 28.

The display device includes a light transmitting cover 34. The cover 34 is made of glass. The cover 34 includes a printing layer 36. To be in more detail, the printing layer 36 is formed into a frame shape in a state where the printing layer 36 surrounds a center portion of the cover 34 by avoiding the center portion of the cover 34. For example, the printing layer 36 surrounds a display region. The cover 34 includes a coating layer 38 which covers at least a surface of the printing layer 36 on a side opposite to the cover 34. The coating layer 38 is made of a material harder than a material of the printing layer 36.

The cover 34 includes the printing layer 36 on a surface thereof which faces the display panel 10. Although a display screen of the display panel 10 is covered with the light transmitting cover 34, the display region is arranged inside the printing layer 36. Here, the touch panel 24 is interposed between the cover 34 and the display panel 10 and hence, the cover 34 is adhered to the touch panel 24 by way of an adhesive layer 40. The adhesive layer 40 is transparent. The adhesive layer 40 is adhered to the touch panel 24 and the coating layer 38 of the cover 34. The adhesive layer 40 is adhered to a part of a portion of the coating layer 38 which overlaps with the printing layer 36 and a portion of the coating layer 38 which does not overlap with the printing layer 36. Accordingly, a portion of the printing layer 36 is covered with the coating layer 38, but is not covered with the adhesive layer 40.

According to this embodiment, the printing layer 36 is covered with the coating layer 38 and hence, it is possible to prevent the occurrence of flaws on the printing layer 36.

### [Modification]

FIG. 4 is a view for explaining a modification 1 of the display device according to the embodiment of the invention. In this modification, a cover 134 shown in FIG. 4 is used in place of the cover 34 shown in FIG. 3. In the example shown in FIG. 3, the coating layer 38 further covers the center portion of the cover 34. In the example shown in FIG. 4, however, a coating layer 138 covers a printing layer 136 but does not cover a center portion of the cover 134.

FIG. 5 is a view for explaining a modification 2 of the display device according to the embodiment of the invention. In this modification, a cover 234 shown in FIG. 5 is used in place of the cover 34 shown in FIG. 3. The cover 234 shown in FIG. 5 includes a base material layer 242. The base material layer 242 is made of an acrylic resin. The cover 234 also includes a surface layer 244 which covers only one surface of the base material layer 242. The surface layer 244 is made of a material harder than a material of the base material layer 242. The surface layer 244 is transparent and has no color. The printing layer 236 and the coating layer 238 are formed on a surface of the base material layer 242 where the surface layer 244 is not present.

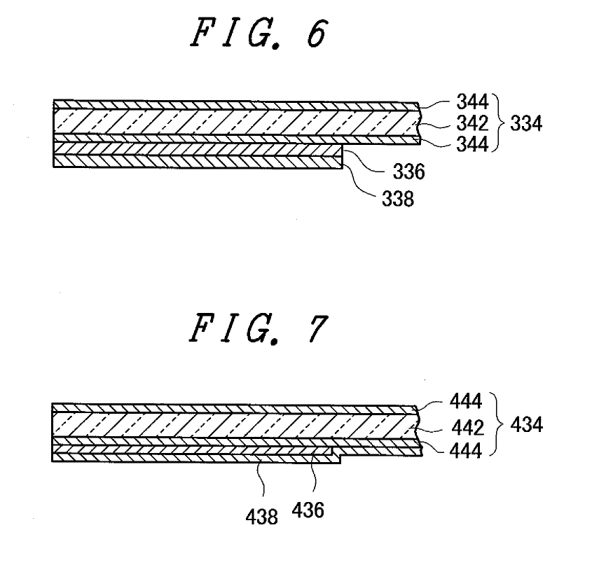

FIG. 6 is a view for explaining a modification 3 of the display device according to the embodiment of the invention. In this modification, a cover 334 shown in FIG. 6 is used in place of the cover 34 shown in FIG. 3. The cover 334 shown in FIG. 6 includes a base material layer 342. The base material layer 342 is made of an acrylic resin. The cover 334 includes surface layers 344 which cover both surfaces of the base material layer 342 respectively. The surface layers 344 are made of a material harder than a material of the base material layer 342. The surface layers 344 are transparent and have no color. A printing layer 336 is formed on one surface layer 344, and a coating layer 338 is formed only on the printing layer 336. That is, the coating layer 338 is formed on the surface layer 344 by way of the printing layer 336 but is not formed to be in contact with the surface layer 344.

FIG. 7 is a view for explaining a modification 4 of the display device according to the embodiment of the invention. In this modification, a cover 434 shown in FIG. 7 is used in place of the cover 34 shown in FIG. 3. The cover 434 shown in FIG. 7 includes a base material layer 442. The base material layer 442 is made of an acrylic resin. The cover 434 includes surface layers 444 which cover both surfaces of the base material layer 442 respectively. The surface layers 444 are made of a material harder than a material of the base material layer 442. The surface layers 444 are transparent and have no color. A printing layer 436 is formed on one surface layer 444. A coating layer 438 is formed on the printing layer 436 and the surface layer 444. To be in more detail, the coating layer 438 is formed to be in contact also with the surface layer 444.

The invention is not limited to the above-mentioned embodiment and various modifications are conceivable. For example, the constitution explained in conjunction with the above-mentioned embodiments may be replaced with the constitution which is substantially equal to the above-mentioned constitution, the constitution which can obtain the same manner of operation and advantageous effects as the above-mentioned constitution, or the constitution which can achieve the same object as the above-mentioned constitution.

What is claimed is:

1. A display device comprising:
a display panel; and
a light transmitting cover which covers a display screen of the display panel, wherein
the cover includes a frame-shaped printing layer which is formed on a surface of the cover which faces the display panel in a state where the printing layer surrounds a center portion of the cover by avoiding the center portion, and a coating layer which covers the printing layer and is made of a material harder than a material of the printing layer.

2. A display device according to claim 1, wherein the coating layer covers the center portion of the cover.

3. A display device according to claim 1, wherein the cover includes a base material layer and a surface layer which covers one surface of the base material layer and is made of a material harder than a material of the base material layer, and
the printing layer and the coating layer are formed on the surface layer.

4. A display device according to claim 2, wherein the cover includes a base material layer and a surface layer which covers one surface of the base material layer and is made of a material harder than a material of the base material layer, and
the printing layer and the coating layer are formed on the surface layer.
